(19) United States
(12) Patent Application Publication
(10) Pub. No.: US 2006/0287197 A1
(43) Pub. Date: Dec. 21, 2006

(54) Mehtod and device for obtaining highly reactive calcium sorbents and/or of binding materials

(76) Inventors: Jacek Maslanka, Warsaw (PL); Bronislhw Ptaszek, Warsaw (PL)

Correspondence Address: KATTEN MUCHIN ROSENMAN LLP, 575 MADISON AVENUE, NEW YORK, NY, 10022-2585, US

(21) Appl. No.: 10/556,933

(22) PCT Filed: Nov. 4, 2003
(86) PCT No.: PCT/PL03/00115

§ 371 Date: Nov. 10, 2005

(30) Foreign Application Priority Data
May 13, 2003 (PL) P 360102

(51) Int. Cl. B01J 20/00

(52) U.S. Cl. 502/400; 422/224; 422/225

(57) ABSTRACT

A method and apparatus is provided for fabrication of highly reactive calcium sorbents and/or binding materials, from powdered calcium carbonate and/or fly-ashes coming from coal combustion, especially in boilers with fluidised bed furnaces. A method is provided in which ashes with chemical by weight containing from 25% up to 45% SiO2, from 3% up to 25% Al2O3, from 10% up to 40% CaO, from 5% up to 15% SO3, beneficially with 51% addition of Portland cement or slag or clinker as activator, are beneficially pre-mixed with calcium carbonate and then the mixture or ashes are mechanically deagglomerated and activated through free particles collisions at the speed at least 8 m/sec. A device is provided including a container closed with cover and the chamber, in which the ashes inlet pipe is located centrally within the rotor axis and finished with the tapered, expanding down outlet.

The subject of invention is the method and the device for obtaining highly reactive calcium sorbents and/or binding materials, from de-agglomerated calcium carbonate and/or fly-ashes, coming from combustion of coal fuels, especially in boilers with fluidized bed furnaces.

The purpose of highly reactive calcium sorbents is to remove sulfur compounds from the hot exhaust gases, created during combustion of coal fuels, especially in boilers with fluidized bed furnaces, or in boilers with powdered-fuel burners, where the dry desulfurization is applied. Binding materials are assigned especially for usage m building industry.

There are known calcium sorbents for cleaning of exhaust gases, obtained by chemical modification. There are also known devices for obtaining sorbents by chemical modification.

There is known, from Polish description of patent application No P-345913, method for obtaining highly reactive calcium sorbents, characterized in that the de-agglomerated calcium sorbent with grain size below 150 μm and at least 92% by weight content of CaCO₃, is mechanically de-agglomerated and activated through free particles collisions at the speed min 8 m/sec.

Method variation for obtaining the highly reactive calcium sorbents, from de-agglomerated calcium carbonate and/or fly-ashes, characterized in that to de-agglomerated calcium carbonate with grain size below 150 μm, beneficially to 30 μm and CaCO₃ content min 92% by weight, fly-ashes are added from combustion of coal fuels, especially in in boilers with fluidized bed furnaces or boilers equipped with powdered-fuel burners, where dry desulfurization of exhaust gases is used, which contain by weight 4% up to 40% of CaO, from 25% up to 45% SiO₂, from 3% up to 37% Al₂O₃, and where content of calcium carbonate in the mixture with fly-ashes is 20÷60% by weight, beneficially 40% by weight, and so prepared mixture of calcium carbonate and fly-ashes is being mechanically de-agglomerated and activated, through free particles collisions at the speed at least 8 m/sec.

The next method variation for obtaining the highly reactive calcium sorbents from de-agglomerated calcium carbonate and/or fly-ashes is characterized in that the fly-ashes coming from combustion of coal fuels, especially in boilers with fluidized bed furnaces and equipped with powdered-fuel burners, where the dry desulfurization of exhaust gases is being used, which contain by weight 4% up to 40% CaO, from 25% up to 45% SiO₂, from 3% up to 37% Al₂O₃ are being mechanically de-agglomerated and activated through free particles collisions at the speed at least 8 m/sec.

There is known, from the patent description No 134 580, the activated cement-ash binding material, which contains cement and fly-ashes from hard coal, in weight proportion 1:1.2 to 1:0.8 and from 0.015 up to 0.025 weight parts of chemical activator consisting of mixture of strong iron and sodium salts, beneficially mixture of sodium chloride, sodium sulfate, iron sulfate and/or copperas. The binding material is being mechanically and chemically activated through milling with chemical activator until the appropriate surface is obtained.

There is known, from the description of international application PCT No WO 9933762, the grout for injection, incorporating the fly-ashes. The compound, according to application includes: water, hydraulic binding material as cement and at least 100 kg/m³ of fly-ashes coming from combustion of coal in fluidized bed furnace.

There is also known, from the Polish patent description No 180 380, device characterized in that the cylindrical part of container is finished with the cover, covered from inside with the dielectric material. In the cylindrical part of container there is the cylindrical process chamber, supported by brackets. The chamber has a conic cover, open at the top and having inside, at bottom a ring, around his perimeter. The chamber has in the upper part a ring, with holes placed around the perimeter, and in the lower part has a bottom equipped with a central hole and a series of circumferential holes. The chamber is also equipped with the inlet pipe, connected to the feeder, finished at the bottom with the disc and rotor which comprises a disc with radial blades, which have beaters on the ends, and the disc is coupled to the shaft, rotary mounted in the vertical axle of container. In the chamber bottom and in the holes of the chamber, ring beating rods are fastened. Between the inside container wall and outsider chamber wall, steel bands are hanging down, placed on the brackets around the chamber.

Method of obtaining highly reactive calcium sorbents, according to invention, based on mechanical de-agglomeration and activation, through free collisions of particles, at the speed at least 8 m/sec, of the mixture containing 20÷60% by weight, beneficially 40% of de-agglomerated calcium carbonate, with grain size below 150 μm and content at least 92% by weight of pure CaCO₃ with fly-ashes, coming from the combustion of coal fuels, especially in boilers with fluidized bed furnaces or equipped with powdered fuel burners, where the dry desulfurization is used, characterized in that calcium carbonate is being pre-mixed with fly-ashes containing by weight 25% up to 45% of SiO₂, from 3% to 25% of Al₂O₃, from 10% to 40% CaO, from 5% to 15% SO₃, and then the mixture is mechanically de-agglomerated and activated.

In the second variation of invention for obtaining the highly reactive calcium sorbents, through mechanical de-agglomeration and activation through free collisions of particles at the speed at least 8 m/sec, of fly-ashes, coming from combustion of coal fuels, especially in boilers with fluidized bed furnaces or equipped with powdered fuels burners, where the dry desulfurization is used, characterized in that fly-ashes containing by weight from 25% to 45% of SiO₂, from 3% to 25% Al₂O₃, from 10% to 40% CaO, from 5% to 15% SO₃ are mechanically de-agglomerated and activated.

In the third variation of invention, method of obtaining materials from fly-ashes, coming from combustion of coal fuels, especially in boilers with fluidized bed furnaces or equipped with powdered fuel burners, where the dry desulfurization is used, through mechanical de-agglomeration and activation by free particles collisions, at the speed at least 8 m/sec, characterized in that ashes containing by weight from 25% to 45% of SiO₂, from 3% to 25% Al₂O₃, from 10% to 40% CaO, from 5% to 15% SO₃, beneficially with addition up tp 51% of activator, are being mechanically de-agglomerated and activated. As activator, the Portland cement or the slag, or linker, or the mixture 0.1 to 51% by weight, beneficially 5 to 20%, is used.

Calcium carbonate and/or fly-ashes are, according to invention method, mechanically activated, result of which is the increase of specific surface of the activated material. Beside the increase of specific surface, surfaces with adsorbed contaminations are cleaned and made able to react with intentionally introduced compounds. Thanks to this, the usage of sorbent surface is more efficient.

During the mechanical activation, there can be in grains local stress irregularities, caused for example by irregular shape and size of material being activated. This situation can lead to creation of new micro-cracks, dislocations, different types of lattice defects, and also propagation of existing cracks, thus boosting the de-agglomeration process. Shape and size irregularities of material being mechanically activated may also lead to creation of local stress irregularities. In mechanism of mechanical activation very important are different kinds of contaminations, which support the de-agglomeration process.

By introduction of fly-ashes to calcium carbonate and activation of such mixture, cleaning of existing surfaces and creation of new ones, through friction, are intensified. This is because the fly-ashes include silica compounds, characterized by high hardness, which for SiO₂ is k=7. Silica plays then, in mechanical activation, the role of grinding medium.

During process of mechanical activation of the calcium carbonate and fly-ashes mixture, particles of fine-grained calcium carbonate may deposit on fly-ashes grains, thus counter-acting to creation of agglomerates and may create much more reactive calcium-silica compounds.

Method according to invention allows for management of big quantities of waste, which is very fine-grained calcium carbonate (below 150 μm). Moreover the possibility to mix, according to invention method, very fine-grained calcium carbonate with fly-ashes and mechanically activate this mixture, as well as mechanical activation of fly-ashes, allows for enlarging the scale of waste disposal, what is very significant from the environment protection point of view.

Device for obtaining the highly reactive calcium sorbents, according to invention, consisting of the container with cover, which has a dielectric layer inside, of the chamber closed with an open cone, with flat bottom, with central hole, where the shaft passes through, having a rotor with radial arms fastened to it, and bearings of the shaft and rotor drive are covered with dustproof housing, and inside the chamber there is a grid of rods, characterized in that the ashes inlet pipe located centrally, in the axis of the rotor, has a tapered, expanding to the bottom outlet. To rotor disc, set of arms ist fastened, which have angle blades, and every second arm is in the plane of rotor disc, whereas the others have a 1° to 2.5° rise. Between the outer cylindrical surface of chamber and inside, cylindrical surface of container there is a cylindrical basket, electrically connected to the body of container.

Rotor of the device, according to invention, gives necessary energy to dense aerosol of activated through free collisions particles and causes creation of lattice defects in multi layers sorbents structure as well as spheroidizing of ash particles. As result of activation, on the surface of defected particles, static charge are emerging, and cause separation of activated and non-activated material, thus high effectivity of activation process and high quality of activated material are achieved.

Device, according to invention, is characterized by high output and efficiency. Because the chamber is open at the top, activated sorbent particles are removed and device reliability is increased. Process rods and rotor blades do not have excessive wear, because they are made from abrasion resisting materials. Dielectric inside layer of the cover makes settling of calcium sorbents particles, with excessive static charge and falling back into chamber, impossible. Rotor blades assure proper transportation of calcium carbonate and/or fly-ashes to the chamber and eliminate the possibility of throwing the material from chamber out, through the central hole in the bottom, before de-agglomeration and activation process of calcium sorbent take place.

Mechanical activation taking place in the device, according to invention, is a physical process, which does not require chemical reagents, laboureous and expensive researches, concerning theirs long lasting influence on the sorbent.

Device according to invention allows for obtaining cheap, highly efficient calcium sorbents, which assure high, from environment protection point of view, effectivity of desulfurization of exhaust gases, coming from combustion of coal fuels, especially in boilers with fluidized bed furnaces, where the dry desulfurization of exhaust gases is used.

The subject of invention is presented as execution example on the drawing, where

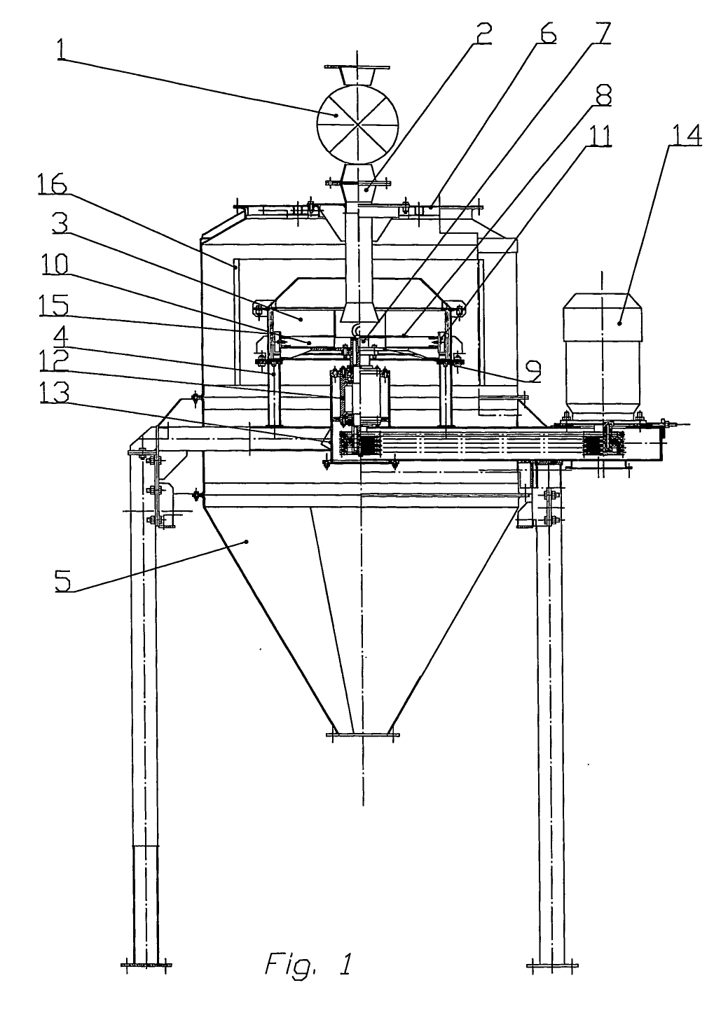

FIG. 1 shows the device in partial longitudinal cross-section,

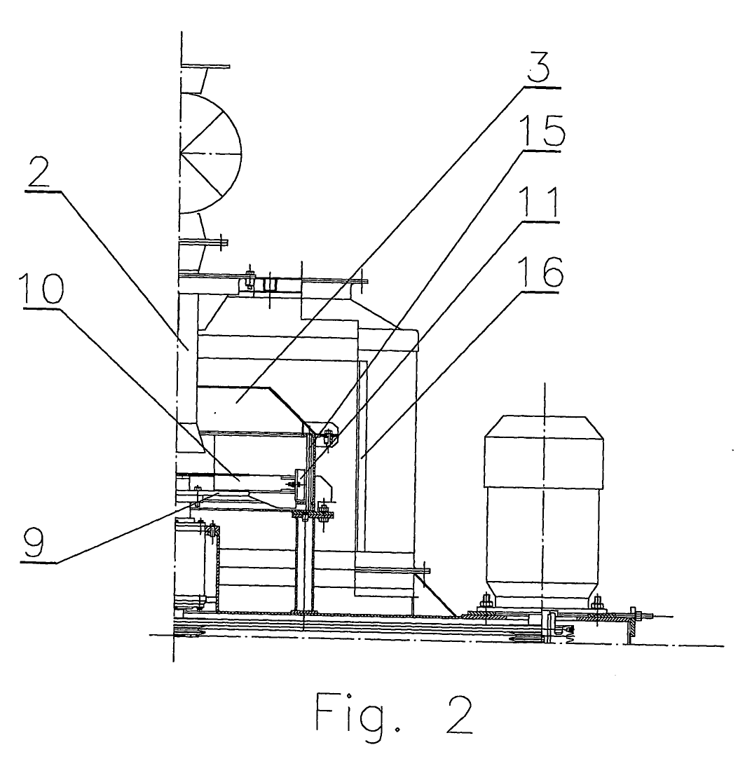

FIG. 2—the increased detail from FIG. 1, including half cross-section of the chamber,

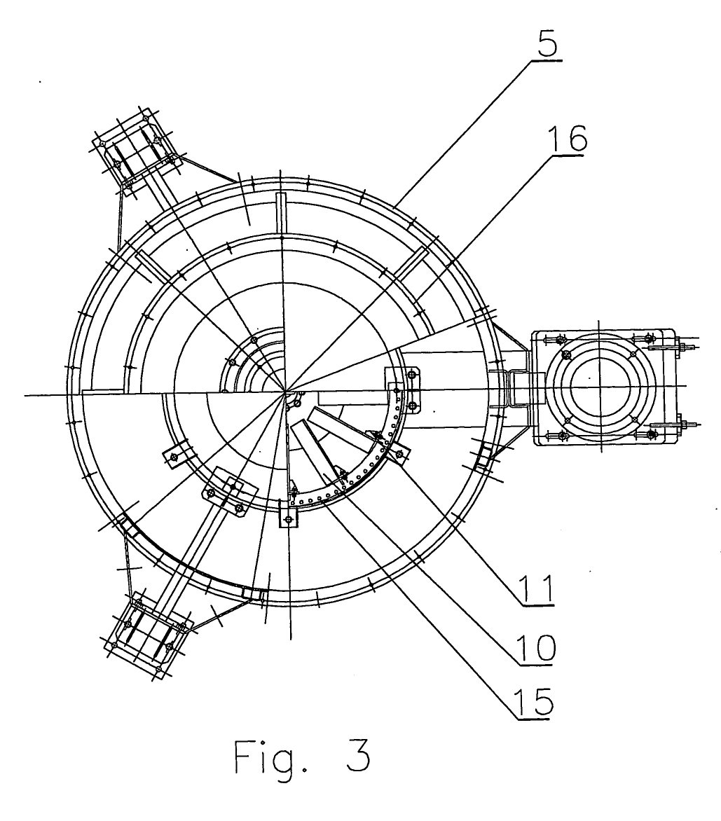

FIG. 3—top view of the device, with part of the rotor, blades fastened for the case of CW rotation.

The device consists of the feeder 1, metering the material being activated, inlet pipe 2 for ashes and the process chamber 3, supported by brackets 4. The container 5 is closed with cover 6, with inside dielectric layer. The process chamber 3 is covered at the top with an opened cone, and down closed with a flat bottom, with the central hole, where the shaft 7 passes through, with rotor 8 fastened to it. To the disc 9 of rotor 8, arms 10 are radially fastened, and on theirs ends angle blades 11 are located. Bearings 12 of rotor 8 are closed in the dust-proof housing 13, which protects also his drive connected to electric motor 14. Inside the process chamber there is a grid of rods 15. The cylindrical basket 16 intensifying the segregation of material being activated, is fixed in the space between processing chamber and container.

The charge in form of calcium carbonate and/or fly-ashes, doming from combustion of coal, especially in boilers with fluidized bed furnaces or boilers equipped with powdered fuel burners, where the dry desulfurization is used, is being introduced with metering feeder 1 through the inlet pipe 2 on the rotating with specified speed rotor 8. Particles of ashes are being transported with arms 10 of rotor 8 on angle blades 11 and thrown as dense aerozol in direction of rods 15, colliding with them at the speed at least 8 m/sec. Result of the collisions are lattice defects in multi-layer envelope of particles, micro-cracks, dislocations. Big particles of ash are de-agglomerated, there is also spheroidizing of ash particles, because of internal friction in dense aerosol. As result of activation, static charges are emerging on the surface of defected particles, causing separation of activated and non-activated material. Because of electrostatic repulsion, particles are leaving the process chamber 3 and settling on walls of container 5 and basket 16, where the excessive static charge is discharged and particles are slipping down into conic part of container 5. The accumulated, in conic part, active calcium sorbent shows sorbent properties, used by cleaning of exhaust gases from sulfur oxides, doming from combustion of coal fuels in boilers with fluidized bed furnaces, boilers equipped with powdered fuel burners, where the dry desulfurization is used.

Below an example for obtaining calcium sorbent according to invention is presented. Sorbent reactivity grade has been established on the base of reactivity indicator Ri.

### EXAMPLE I

### Kontent of Ashes from Boiler with Fluidized Bed Furnace

| | |
|---|---|
| SiO₂ | 39% by weight |
| Al₂O₃ | 21% by weight |
| CaO | 15% by weigth |
| SO₃ | 10% by weight |
| Other chemical compounds | 15% by weight. |

To ashes, as shown above, 40% by weight of calcium carbonate, coming from milling in Elektrownia Turów, has been added, containing 95.6% CaCO₃ by weight, and having grain size below 150 μm, and mixture has been introduced to device according to invention, and then mechanically de-agglomerated and activated through free collisions of calcium carbonate particles, at the speed at least 8 m/sec.

As result of mechanical activation in device according to invention, calcium sorbent has been obtained, with reactivity indicator RI=1.86, what places it in the class of high quality sorbents (RI<2.5).

Thanks to method and device for obtaining highly reactive calcium sorbents by mechanical activation of fine grained calcium carbonate, mixtures of ashes and carbonates and also fly-ashes, cheap calcium sorbents of high reactivity indicators RI, placed in the best class sorbents with indicator below 2.5 are obtained. The best reactivity indicators of these sorbents, depending on calcium carbonate weight in weight concentration, have reactivity indicator below 2.0. Optimum results are especially obtained for calcium sorbent with weight in weight concentration 40% of calcium carbonate in the mixture of: fly-ashes and calcium carbonate. Reactivity indicator of this calcium sorbent is RI=1.86.

Below an example of binding material obtained by invention method.

### EXAMPLE 2

### Content of Ashes from Boiler with Fluidized Bed Furnace

| | |
|---|---|
| SiO₂ | 39,80 % by weight |
| Al₂O₃ | 21,10 % by weight |
| GaO | 15,14 % by weight |
| SO₃ | 7,96 % by weight |
| Other chemical compounds | 16,00 % by weight |

To ashes as above, Portland cement CEMI 32.5 in proportion 9:1 has been added and the mixture has been introduced to device, according to invention, where the particles have been mechanically de-agglomerated and activated through free collisions at the speed 8 m/sec. As result of this process, homogeneous product with particles of regular shape and excessive static charge has been obtained. Product has binding features and after mixing with water in proportion 0.32 until plastic is obtained and keeping in normal conditions for 28 days, it has the following parameters:

| | | |
|---|---|---|
| compression strength | 34,00 | MPa |
| bending strength | 7,50 | MPa |
| density | 1810 | kg/m³ |

| | |
|---|---|
| dilatation | ± 0,03% |

1. Method for obtaining highly reactive calcium sorbents from fine grained calcium carbonate and/or fly-ashes, through mechanical de-agglomeration and activation by free particles collisions at the speed at least 8 m/sec., of the mixture containing 20÷60% by weight, beneficially 40% of fine grained calcium carbonate with grain size below 150 μm and content at least 92% by weight of pure CaCO₃ with fly-ashes, doming from combustion of coal fuels, especially in boilers with fluidized bed furnaces or equipped with powdered fuel burners, where the dry desulfurization of exhaust gases is used, characterized in that calcium carbonate is being preliminary mixed with ashes containing by weight from 25% to 45% of SiO₂, from 3% to 25% of Al₂O₃, from 10% to 40% of CaO, from 5% to 15% of SO₃, and then the mixture is being mechanically de-agglomerated and activated.

2. Method for obtaining the highly reactive calcium sorbents, from fine grained calcium carbonate and/or fly-ashes, through mechanical de-agglomeration and activation by free collisions of particles at the speed at least 8 m/sec of fly-ashes, coming from combustion of coal fuels, especially in boilers with fluidized bed furnaces or equipped with powdered fuel burners, where the dry desulfurization of exhaust gases is used, characterized in that ashes containing by weight 25% to 45% of SiO₂, from 3% to 25% of Al₂O₃, from 10% to 40% of CaO, from 5% to 15% of SO₃ are mechanically de-agglomerated and activated.

3. Method for obtaning binding materials, from fly-ashes doming from combustion of coal fuels, especially in boilers with fluidized bed furnaces or equipped with powdered fuel burners, where the dry desulfurization of exhaust gases is used, based on mechanical de-agglomeration and activation through free particles collisions at the speed at least 8 m/sec, characterized in that ashes containing by weight from 25% to 45% of SiO₂, from 3% to 25% of Al₂O₃, from 10% to 40% CaO, from 5% to 15% SO₃, beneficially with addition 51% of activator, are being mechanically de-agglomerated and activated.

4. Method for manufacturing the binding materials, according to claim 3, characterized in that as activator the Portland cement or slag, or linker, or their compositions 1 to 51% by weight are used, beneficially 5 to 20% by weight.

5. Device for manufacturing highly reactive calcium sorbents and/or binding materials, consisting of a container closed with cover, which has inside a dielectric layer, of a process chamber, closed with an open cone and a flat bottom, with the central hole, where the shaft with rotor fastened to it, passes through, and disc of rotor has radially fastened arms, bearings of rotor and his drive are covered by dust-proof housing, whereas inside of process chamber there is a grid of rods, characterized in that centrally located in axis of rotor (8) the ashes inlet pipe (2) has a tapered, expanding to bottom outlet, and to the disc (9) of rotor (8) set of arms (10) equipped with angle blades (11), is radially fastened, and every second arm (10) is in the plane of rotor disc (8), the others have a rise from 1° to 2.5°, and between outer, cylindrical surface of process chamber (3) and cylindrical, inside surface of container (5) there is fastened cylindrical basket (16), electrically connected to the body of container (5).
